(19) United States
(12) Patent Application Publication
(10) Pub. No.: US 2026/0118703 A1
(43) Pub. Date: Apr. 30, 2026

(54) TEMPLE ARM AND SMART GLASSES

(71) Applicant: Ningde Amperex Technology Limited, Ningde (CN)

(72) Inventors: Qiong QU, Ningde (CN); Sen LIN, Ningde (CN); Guowen ZHANG, Ningde (CN)

(73) Assignee: Ningde Amperex Technology Limited, Ningde (CN)

(21) Appl. No.: 19/366,564

(22) Filed: Oct. 23, 2025

(30) Foreign Application Priority Data
Oct. 24, 2024 (CN) 202411495585.9

(51) Int. Cl. G02C 11/06; G02C 5/14

(52) U.S. Cl. CPC G02C 11/06; G02C 5/14

(57) ABSTRACT

A temple arm includes a housing, an electrode assembly and an acoustic assembly. The housing includes a first chamber and a second chamber, and along a first direction, a projection of the first chamber covers a projection of the second chamber. The housing includes an ear-hook portion, and the ear-hook portion is connected to the second chamber along a second direction. The first direction is perpendicular to the second direction. The electrode assembly includes an electrode terminal, and the electrode assembly is disposed in the first chamber. The acoustic assembly is disposed in the second chamber and electrically connected to the electrode terminal. The ear-hook portion is connected to the second chamber along the second direction.

### CROSS-REFERENCE TO RELATED APPLICATION

This application claims priority to the Chinese Patent Application Serial No. 202411495585.9, filed on Oct. 24, 2024, the content of which is incorporated herein by reference in its entirety.

### TECHNICAL FIELD

This application relates to the technical field of wearable devices, and in particular, to a temple arm and smart glasses.

### BACKGROUND

Smart glasses belong to a type of wearable device, which are provided with various functional electronic components on the basis of traditional glasses and provide electrical energy to the electronic components through a battery, thereby offering users a rich and diverse functional experience. In the prior art, the space of a temple arm cannot be fully utilized, resulting in limited capacity of the battery that can be installed.

### SUMMARY

Accordingly, this application provides a temple arm and smart glasses, which is conducive to increasing the capacity of an electrode assembly.

In a first aspect of this application, a temple arm is provided and includes a housing, an electrode assembly and an acoustic assembly. The housing includes a first chamber and a second chamber, and along a first direction, a projection of the first chamber covers a projection of the second chamber. The housing includes an ear-hook portion, and the ear-hook portion is connected to the second chamber along a second direction. The first direction is perpendicular to the second direction. The electrode assembly includes an electrode terminal, and the electrode assembly is disposed in the first chamber. The acoustic assembly is disposed in the second chamber and electrically connected to the electrode terminal.

The projection of the first chamber along the first direction covers the projection of the second chamber along the first direction, which is conducive to reducing the restriction of the second chamber on the first chamber along the second direction, conducive to extending the first chamber along the second direction, and thus conducive to enabling the electrode assembly to fully utilize the space of the temple arm and increasing the capacity of the electrode assembly. Moreover, the ear-hook portion is connected to the second chamber along the second direction, which is conducive to enabling the acoustic assembly in the second chamber to be closer to the ear during wearing, thereby improving the auditory experience of the wearer.

In one or more of the above embodiments, the housing includes a third chamber and a fourth chamber, the third chamber is provided with a control assembly, and the fourth chamber is provided with wiring. The electrode terminal and the acoustic assembly are electrically connected to the control assembly, and the fourth chamber is in communication with the second chamber and the third chamber.

In the above embodiments, through the control assembly, it is conducive to adjusting parameters such as input power and volume size of the acoustic assembly, and improving the convenience of controlling the acoustic assembly.

In one or more of the above embodiments, the housing includes a body portion and a cover portion, the cover portion includes a first cover body and a second cover body, the first cover body is integrally arranged with the body portion and includes the first chamber, and the second cover body is detachably assembled with the body portion and includes the second chamber, the third chamber, and the fourth chamber.

In the above embodiments, since the first chamber needs to be filled with an electrolyte solution, the sealing requirement for first chamber is relatively high. By integrally arranging the first cover body and the body portion, it is conducive to reducing the possibility of leakage of the electrolyte solution to the second chamber, the third chamber and the fourth chamber when the electrode assembly is assembled. Moreover, the detachable assembly of the second cover body and the body portion is conducive to improving the convenience of assembling the acoustic assembly, the control assembly and the wiring.

In one or more of the above embodiments, the body portion, the first cover body, and the second cover body are made of a metal material with a specific strength greater than 50,000 N·m/kg and a specific modulus greater than 24,000,000 N·m/kg, or a plastic material with a water permeability not greater than 0.01 g/m2/day.

In the above embodiments, the plastic material is lighter than the metal material, which is conducive to reducing the weight of the temple arm. It is conducive to adopting injection molding to manufacture the body portion, the first cover body and the second cover body from the plastic material, and conducive to simplifying the manufacturing process. The metal material has better sealing performance compared to the plastic material, which is conducive to reducing the possibility of moisture entering the housing, thereby improving the stability of electrical connection among the electrode assembly, the acoustic assembly, and the control assembly. Moreover, since the structural strength of the metal material is greater than that of the plastic material, under the same structural strength requirements, using the metal material can make the body portion and the first cover body thinner, which is conducive to increasing the internal space of the first chamber, thereby increasing the capacity of the electrode assembly.

In one or more of the above embodiments, the body portion includes a first main body and a second main body, and the first main body and the second main body are detachably connected. The first cover body is integrally arranged with the first main body and includes the first chamber, and the second cover body is detachably assembled with the second main body and includes the second chamber, the third chamber, and the fourth chamber.

In the above embodiments, it is conducive to adopting different manufacturing processes to manufacture the first main body and the first cover body, as well as the second main body and the second cover body separately, thereby improving the flexibility of manufacturing the temple arm.

In one or more of the above embodiments, the first main body and the first cover body are made of a metal material with a specific strength greater than 50,000 N·m/kg and a specific modulus greater than 24,000,000 N·m/kg, or a plastic material with a water permeability not greater than 0.01 g/m2/day. The second main body and the second cover body are made of at least one of plastic titanium, tungsten titanium, nylon, carbon fiber, epoxy resin, cellulose acetate, cellulose propionate, or cellulose nitrate.

In the above embodiments, it is conducive to adopting injection molding to manufacture the first main body and the first cover body from the plastic material, and conducive to simplifying the manufacturing process. Alternatively, it is conducive to adopting stamping to manufacture the first main body and the first cover body, and conducive to providing better sealing performance for the first chamber and making the first main body and the first cover body thinner. In addition, using conventional temple arm materials to manufacture the second main body and the second cover body is conducive to improving the convenience of manufacturing the temple arm.

In one or more of the above embodiments, the first main body and the second main body are connected by bonding, snap-fitting, screwing, or riveting.

In the above embodiments, bonding is conducive to improving the convenience of disassembly between the first main body and the second main body, snap-fitting is conducive to improving the stability of the connection between the first main body and the second main body, screwing is conducive to improving the connection strength between the first main body and the second main body, and riveting is conducive to improving the reliability of the connection between the first main body and the second main body.

In one or more of the above embodiments, the second main body is provided with connecting holes, and the connecting holes communicate with the third chamber. The electrode terminal extends into the connecting hole.

In the above embodiments, it is conducive to improving the convenience of electrical connection between the electrode assembly and the control assembly.

In one or more of the above embodiments, the first main body includes the ear-hook portion, and the ear-hook portion and the second main body together form an ear-hook region. In the above embodiments, it is conducive to enabling the acoustic assembly in the second chamber to be closer to the ear during wearing, thereby improving the auditory experience of the wearer.

In one or more of the above embodiments, the ear-hook portion is recessed along a direction opposite to the first direction.

In the above embodiments, it is conducive to enabling the acoustic assembly in the second chamber to be closer to the ear-hook portion along the first direction, thereby improving the auditory experience of the wearer.

In one or more of the above embodiments, the electrode terminal extends out of the first chamber and is located within the housing.

In the above embodiments, it is conducive to the electrical connection between the electrode terminal and the acoustic assembly within the housing.

In one or more of the above embodiments, the temple arm is internally provided with the electrolyte solution, and the electrolyte solution is directly accommodated in the first chamber.

In the above embodiments, the housing of the temple arm directly serves as a shell of the electrode assembly, which is conducive to reducing the space occupied by the shell of the electrode assembly that needs to be additionally provided inside the housing, and thus conducive to increasing the volume available for the electrode assembly within the housing and increasing the capacity of the electrode assembly.

In a second aspect of this application, smart glasses are provided and include a frame, lenses and temple arms according to the first aspect of this application. The lenses are disposed on the frame, and the temple arms are connected to the frame. The temple arms are conducive to increasing the capacity of the electrode assembly, thereby being conducive to prolonging the battery life of the smart glasses.

### BRIEF DESCRIPTION OF DRAWINGS

FIG. 1 is an exploded view of a temple arm according to a first embodiment of this application.

FIG. 2 is a front view of the temple arm according to the first embodiment of this application.

FIG. 3 is an enlarged view of a region A in FIG. 1.

FIG. 4 is a cross-sectional view taken along a line B-B in FIG. 2.

FIG. 5 is a front view of a temple arm according to a second embodiment of this application.

FIG. 6 is an exploded view of the temple arm according to the second embodiment of this application.

### LIST OF REFERENCE NUMERALS

10. Temple arm; 101. Head portion; 102. Middle portion; 103. Leg portion; 104. Ear-hook portion; 11. Housing; 111. Body portion; 1111. First wall; 1112. Second wall; 1113. Third wall; 1114. Fifth wall; 1115. Sound hole; 1116. Connecting hole; 111a. First main body; 111b. Second main body; 112. Cover portion; 1121. Fourth wall; 112a. First cover body; 112b. Second cover body; 12. Electrode assembly; 121. Electrode terminal; 1211. First tab; 1212. Second tab; 1213. First adapter; 1214. Second adapter; 122. First electrode plate; 123. Second electrode plate; 124. Separator; 13. Acoustic assembly; 14. Control assembly; 15. Wiring; Q1. First chamber; Q2. Second chamber; Q3. Third chamber; Q4. Fourth chamber; X. First direction; Y. Second direction; and Z. Third direction.

### DETAILED DESCRIPTION

Technical solutions in embodiments of this application will be described below in conjunction with accompanying drawings in the embodiments of this application. Apparently, the described embodiments are merely some rather than all of the embodiments of this application.

It is hereby noted that when a component is considered to be “connected” to another component, it can be directly connected to another component or may exist at the same time. When a component is considered to be “disposed on” another component, it can be set directly on another component or may exist at the same time.

Unless otherwise expressly specified, the term “a plurality of” as used herein means two or more.

The terms “first”, “second”, and the like are merely used to distinguish between different objects, and shall not be construed as any indication or implication of relative importance or any implicit indication of the quantity, particular sequence or primary-secondary relationship of the technical features indicated.

Unless otherwise defined, all technical and scientific terms used herein bear the same meanings as what is normally understood by a person skilled in the technical field of this application. The terms used herein in the specification of this application are merely for the purpose of describing specific embodiments and are not intended to limit this application. The term “and/or” used herein includes any and all combinations of one or more of the related listed items.

It should be understood that considering actual machining tolerances, in the technical solution of this application, when two components are disposed parallel to/perpendicular to each other along a same direction, a certain angle may exist between the two components, a tolerance of 0−±10% is allowed between the two components, and the two components are greater than, equal to, or less than the allowed tolerance of 0 to ±10%.

In a first aspect of embodiments of this application, a temple arm is provided and includes a housing, an electrode assembly, and an acoustic assembly. The housing includes a first chamber and a second chamber, and along a first direction, a projection of the first chamber covers a projection of the second chamber. The housing includes an ear-hook portion, and the ear-hook portion is connected to the second chamber along a second direction. The first direction is perpendicular to the second direction. The electrode assembly includes an electrode terminal, and the electrode assembly is disposed in the first chamber. The acoustic assembly is disposed in the second chamber and electrically connected to the electrode terminal.

The projection of the first chamber along the first direction covers the projection of the second chamber along the first direction, which is conducive to reducing the restriction of the second chamber on the first chamber along the second direction, conducive to extending the first chamber along the second direction, and thus conducive to enabling the electrode assembly to fully utilize the space of the temple arm and increasing the capacity of the electrode assembly. Moreover, the ear-hook portion is connected to the second chamber along the second direction, which is conducive to enabling the acoustic assembly in the second chamber to be closer to the ear during wearing, thereby improving the auditory experience of the wearer.

Some embodiments of this application will be described below in conjunction with the accompanying drawings. The following embodiments and features in the embodiments may be combined with each other without conflicts.

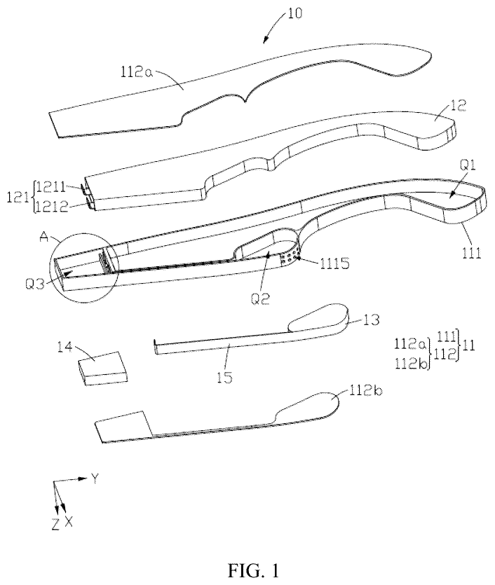

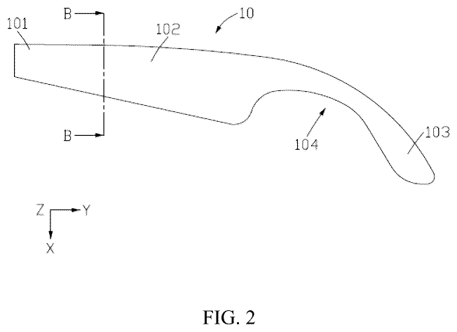

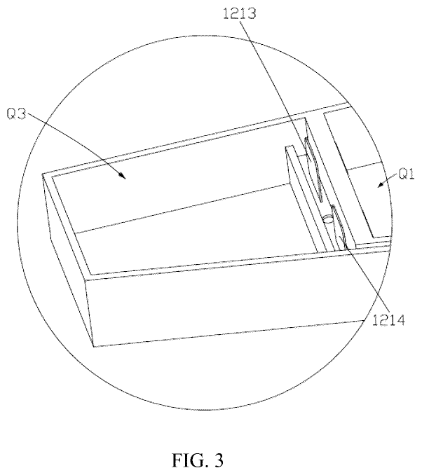

Referring to FIG. 1 to FIG. 3 in combination, an embodiment of this application provides a temple arm 10, which includes a housing 11, an electrode assembly 12, and an acoustic assembly 13.

The housing 11 includes a first chamber Q1 and a second chamber Q2. Along a first direction X, a projection of the first chamber Q1 covers a projection of the second chamber Q2. The first chamber Q1 and the second chamber Q2 do not communicate with each other.

In some embodiments, along a second direction Y, the temple arm 10 is sequentially divided into a head portion 101, a middle portion 102, and a leg portion 103. The head portion 101 is configured to be connected to a frame, and the leg portion 103 is arc-shaped.

In some embodiments, the housing 11 includes an ear-hook portion 104, and the ear-hook portion 104 is connected to the second chamber Q2 along the second direction Y, and forms an ear-hook region.

In some embodiments, the middle portion 102 and the leg portion 103 together form the ear-hook region.

The electrode assembly 12 includes an electrode terminal 121, and the electrode assembly 12 is disposed in the first chamber Q1. The electrode terminal 121 includes a first tab 1211 and a second tab 1212, and the first tab 1211 and the second tab 1212 have opposite polarities. In some embodiments, the electrode terminal 121 only includes the first tab 1211 or the second tab 1212, that is, the electrode terminal 121 only includes a single tab. Alternatively, the electrode terminal 121 includes a plurality of tabs, which is not limited in this application.

In some embodiments, the electrode terminal 121 extends out of the first chamber Q1, and the first tab 1211 and the second tab 1212 directly extend out of the first chamber Q1.

In some embodiments, the electrode terminal 121 includes a first adapter 1213 and a second adapter 1214. The first tab 1211 and the second tab 1212 are located in the first chamber Q1, the first adapter 1213 and the second adapter 1214 are located outside the first chamber Q1, the first adapter 1213 is electrically connected to the first tab 1211, and the second adapter 1214 is electrically connected to the second tab 1212.

In some embodiments, the electrode terminal 121 includes electrode posts (not shown). The first adapter 1213 is electrically connected to the first tab 1211 through the pole, and the second adapter 1214 is electrically connected to the second tab 1212 through the electrode post.

In some embodiments, the first adapter 1213 and the second adapter 1214 are made of one or more conductive materials such as copper, aluminum, nickel, or nickel alloy.

In some embodiments, the temple arm 10 is internally provided with the electrolyte solution, and the electrolyte solution is directly accommodated in the first chamber Q1. In this case, the housing 11 of the temple arm 10 directly serves as a shell of the electrode assembly 12, which is conducive to reducing the space occupied by the shell of the electrode assembly 12 that needs to be additionally provided inside the housing 11, and thus conducive to increasing the volume available for the electrode assembly 12 within the housing 11 and increasing the capacity of the electrode assembly 12.

The first chamber Q1 is filled with the electrolyte solution, and the first chamber Q1 and the second chamber Q2 do not communicate with each other, which is conducive to reducing the impact of the electrolyte solution on the circuit connection and audio quality of the acoustic assembly 13, etc.

The acoustic assembly 13 is disposed in the second chamber Q2 and electrically connected to the electrode terminal 121. The acoustic assembly 13 is configured to output audio. In some embodiments, the acoustic assembly 13 may also be referred to as an audio output assembly or a speaker assembly.

In some embodiments, the electrode terminal 121 extends out of the first chamber Q1 and is located within the housing 11. It is conducive to the electrical connection between the electrode terminal 121 and the acoustic assembly 13 within the housing 11.

In some embodiments, the ear-hook portion 104 is recessed along a direction opposite to the first direction X. It is conducive to enabling the acoustic assembly 13 in the second chamber Q2 to be closer to the ear-hook portion 104 along the first direction X, thereby improving the auditory experience of the wearer.

The first direction X is parallel to a height direction of the temple arm 10, the second direction Y is parallel to a length direction of the temple arm 10, and a third direction Z is parallel to a width direction of the temple arm 10. The first direction X, the second direction Y, and the third direction Z are mutually perpendicular to each other.

The projection of the first chamber Q1 along the first direction X covers the projection of the second chamber Q2 along the first direction X, which is conducive to reducing the restriction of the second chamber Q2 on the first chamber Q1 along the second direction Y, conducive to extending the first chamber Q1 along the second direction Y, and thus conducive to enabling the electrode assembly 12 to fully utilize the space of the temple arm 10 and increasing the capacity of the electrode assembly 12. The above ear-hook portion 104 and the second chamber Q2 form the ear-hook region, which is conducive to enabling the acoustic assembly 13 in the second chamber Q2 to be closer to the ear during wearing, thereby improving the auditory experience of the wearer.

In some embodiments, the housing 11 is connected to the frame, either through a fixed connection or a hinge connection. When the housing 11 is hinged to the frame, it is conducive to the rotation of the temple arm 10 relative to the frame, thereby facilitating the storage of the temple arm 10.

In some embodiments, the electrode assembly 12 is a stacked electrode assembly. The stacked electrode assembly includes a first electrode plate 122, a second electrode plate 123 and a separator 124. The first electrode plate 122 and the second electrode plate 123 have opposite polarities, the separator 124 is disposed between the first electrode plate 122 and the second electrode plate 123, and the first electrode plate 122 and the second electrode plate 123 are sequentially stacked. The first tab 1211 is connected to the first electrode plate 122, and the second tab 1212 is connected to the second electrode plate 123. The stacked electrode assembly is conducive to adapting to an irregular space of the temple arm 10, which is conducive to more fully utilizing the space of the temple arm 10, thereby improving the energy density of the electrode assembly 12.

In some embodiments, the first electrode plate 122 is a positive electrode plate, and the second electrode plate 123 is a negative electrode plate. Alternatively, the first electrode plate 122 is a negative electrode plate, and the second electrode plate 123 is a positive electrode plate.

In other embodiments, the electrode assembly 12 is a jelly-roll electrode assembly, and a first electrode plate 122, a second electrode plate 123 and a separator 124 of the jelly-roll electrode assembly are wound together. The jelly-roll electrode assembly has higher production efficiency, which is conducive to improving the production efficiency of the temple arm 10.

In some embodiments, the housing 11 includes a third chamber Q3, the third chamber Q3 is in communication with the second chamber Q2, and the third chamber Q3 and the first chamber Q1 do not communicate with each other. The third chamber Q3 is provided with a control assembly 14, and the electrode terminal 121 and the acoustic assembly 13 are electrically connected to the control assembly 14. Through the control assembly 14, it is conducive to adjusting parameters such as input power and volume size of the acoustic assembly 13, thereby improving the convenience of controlling the acoustic assembly 13. The third chamber Q3 does not communicate with the first chamber Q1, which is conducive to reducing the impact of the electrolyte solution on circuit connections and electronic components of the control assembly 14.

In some embodiments, the control assembly 14 includes a circuit board, and the circuit board is provided with electrical components such as a memory and a processor. The memory stores preset control instructions, and the processor is configured to read and execute the control instructions.

In some embodiments, the first chamber Q1 is connected to the third chamber Q3 along the second direction Y, and the electrode terminal 121 extends toward the third chamber Q3, which is conducive to improving the convenience of electrical connection between the electrode terminal 121 and the control assembly 14.

In some embodiments, the housing 11 includes a fourth chamber Q4, the fourth chamber Q4 is in communication with the second chamber Q2 and the third chamber Q3, and the fourth chamber Q4 is provided with wiring 15, which is conducive to the electrical connection between the acoustic assembly 13 and the control assembly 14 through the wiring 15. The first chamber Q1 and the fourth chamber Q4 do not communicate with each other. This is conducive to reducing the impact of the electrolyte solution on the circuit connection of the wiring 15.

In some embodiments, the wiring 15 is a flexible printed circuit. The flexible printed circuit occupies a smaller space, which is conducive to reducing the space required for the fourth chamber Q4, and thus conducive to increasing the space of the first chamber Q1 and increasing the capacity of the electrode assembly 12.

In some embodiments, the third chamber Q3 is located at the head portion 101, and the first chamber Q1 is connected to the third chamber Q3 along the second direction Y and extends toward the leg portion 103. The second chamber Q2 is located at the middle portion 102, and along the first direction X, the second chamber Q2 is located below the first chamber Q1. The fourth chamber Q4 extends from the third chamber Q3 to the second chamber Q2. Since the second chamber Q2 participates in forming the ear-hook region, by arranging the second chamber Q2 and the third chamber Q3 separately and communicating through the fourth chamber Q4, it is conducive to reducing the internal space of the temple arm 10 occupied by the third chamber Q3 along the first direction X, and thus conducive to increasing the space of the first chamber Q1 and increasing the capacity of the electrode assembly 12.

In some embodiments, the housing 11 includes a body portion 111 and a cover portion 112, and the body portion 111 and the cover portion 112 together form the first chamber Q1, the second chamber Q2, the third chamber Q3, and the fourth chamber Q4.

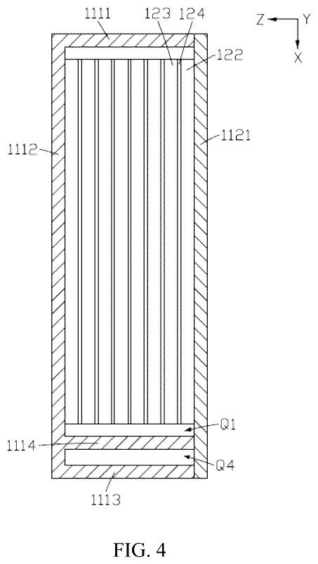

Referring to FIG. 4, in some embodiments, the body portion 111 includes a first wall 1111, a second wall 1112, and a third wall 1113 which are sequentially connected, and the cover portion 112 includes a fourth wall 1121. Along the first direction X, the first wall 1111 is opposite to the third wall 1113. Along the third direction Z, the second wall 1112 is opposite to the fourth wall 1121. The fourth wall 1121 covers the first wall 1111 and the third wall 1113 along the third direction Z.

In some embodiments, the electrode assembly 12 abuts against the second wall 1112 and the fourth wall 1121, and the electrode assembly 12 is a stacked electrode assembly. A stacking direction of the first electrode plate 122 and the second electrode plate 123 is parallel to the third direction Z. It is conducive to reducing the possibility of movement of the electrode assembly 12 within the first chamber Q1 and improving the stability of the electrode assembly 12.

In some embodiments, the body portion 111 includes a fifth wall 1114. Along the third direction Z, the fifth wall 1114 is connected to the second wall 1112 and the fourth wall 1121, and is located between the first wall 1111 and the third wall 1113 along the first direction X.

In some embodiments, the first chamber Q1 includes the first wall 1111, a portion of the second wall 1112, the third wall 1113, and a portion of the fourth wall 1121. The fourth chamber Q4 includes the fifth wall 1114, a portion of the second wall 1112, the third wall 1113 and a portion of the fourth wall 1121. The first chamber Q1 and the fourth chamber Q4 are separated by the fifth wall 1114.

In some embodiments, referring to FIG. 1, the body portion 111 includes sound holes 1115, and the sound holes 1115 penetrate through an inner wall and an outer wall of the second chamber Q2. The sound holes 1115 are conducive to transmitting the sound generated by the acoustic assembly 13, and improving the clarity of the sound heard by the wearer.

In some embodiments, the body portion 111 may not include the sound holes 1115, and the acoustic assembly 13 outputs audio through bone conduction.

In some embodiments, the cover portion 112 includes a first cover body 112a and a second cover body 112b. The first cover body 112a is integrally arranged with the body portion 111 and includes the first chamber Q1. The second cover body 112b is detachably assembled with the body portion 111 and includes the second chamber Q2, the third chamber Q3, and the fourth chamber Q4.

Since the first chamber Q1 needs to be filled with an electrolyte solution, the sealing requirement for first chamber Q1 is relatively high. By integrally arranging the first cover body 112a and the body portion 111, it is conducive to reducing the possibility of leakage of the electrolyte solution to the second chamber Q2, the third chamber Q3, and the fourth chamber Q4 when the electrode assembly 12 is assembled. Moreover, the detachable assembly of the second cover body 112b and the body portion 111 is conducive to improving the convenience of assembling the acoustic assembly 13, the control assembly 14, and the wiring 15.

The first cover body 112a being integrally arranged with the body portion 111 means that the first cover body 112a and the body portion 111 are complete as a whole and non-detachable. In some embodiments, after assembling the electrode assembly 12 to the body portion 111 and filling with the electrolyte solution, the first cover body 112a then covers the body portion 111, making the first cover body 112a and the body portion 111 non-detachable by melting at the covering position.

In some embodiments, the body portion 111, the first cover body 112a and the second cover body 112b are made of a plastic material. The plastic material is lighter than the metal material, which is conducive to reducing the weight of the temple arm 10. It is conducive to adopting injection molding to manufacture the body portion 111, the first cover body 112a and the second cover body 112b from the plastic material, and conducive to simplifying the manufacturing process.

In some embodiments, the plastic material has a water permeability of no greater than 0.01 g/m2/day.

In some embodiments, the plastic material having a water permeability of no greater than 0.01 g/m²/day is a liquid crystal polymer material (LCP), polytrifluorochloroethylene (PCTFE), or the like.

In some embodiments, the body portion 111, the first cover body 112a, and the second cover body 112b are made of a metal material. The metal material has better sealing performance compared to the plastic material, which is conducive to reducing the possibility of moisture entering the housing 11, thereby improving the stability of electrical connection between the electrode assembly 12, the acoustic assembly 13, and the control assembly 14. Moreover, since the structural strength of the metal material is greater than that of the plastic material, under the same structural strength requirements, using the metal material can make the body portion 111 and the first cover body 112a thinner, which is conducive to increasing the internal space of the first chamber Q1, thereby increasing the capacity of the electrode assembly 12.

In some embodiments, the metal material has a specific strength greater than 50,000 N·m/kg and a specific modulus greater than 24,000,000 N·m/kg.

In some embodiments, the body portion 111, the first cover body 112a, and the second cover body 112b are manufactured from the metal material using stamping.

In some embodiments, the metal material having a specific strength greater than 50,000 N·m/kg and a specific modulus greater than 24,000,000 N·m/kg is magnesium alloy, aluminum alloy, titanium alloy, or other materials.

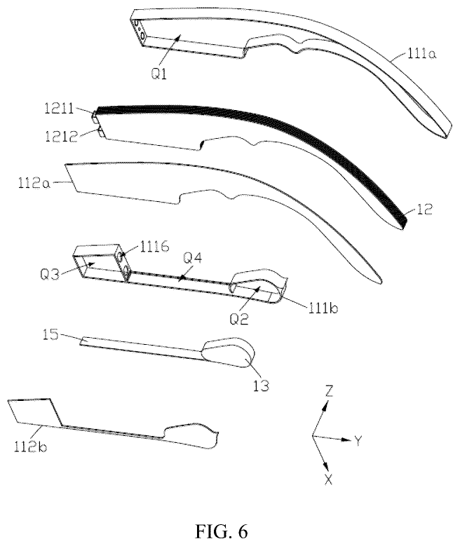

In some embodiments, referring to FIG. 6, the body portion 111 includes a first main body 111a and a second main body 111b. The first main body 111a and the second main body 111b are detachably connected. The first cover body 112a is integrally arranged with the first main body 111a and includes the first chamber Q1, and the second cover body 112b is detachably assembled with the second main body 111b and includes the second chamber Q2, the third chamber Q3, and the fourth chamber Q4. It is conducive to adopting different manufacturing processes to manufacture the first main body 111a and the first cover body 112a, as well as the second main body 111b and the second cover body 112b separately, thereby improving the flexibility of manufacturing the temple arm 10.

The first cover body 112a being integrally arranged with the first main body 111a means that the first cover body 112a and the first main body 111a are complete as a whole and non-detachable. In some embodiments, after assembling the electrode assembly 12 to the first main body 111a and filling with the electrolyte solution, the first cover body 112a then covers the first main body 111a, making the first cover body 112a and the first main body 111a non-detachable by melting at the covering position.

In some embodiments, the first main body 111a and the first cover body 112a are made of a plastic material, and the water permeability of the plastic material is no greater than 0.01 g/m2/day. It is conducive to adopting injection molding to manufacture the first main body 111a and first cover body 112a from the plastic material, and conducive to simplifying the manufacturing process.

In some embodiments, the first main body 111a and first cover body 112a are made of a metal material, and the metal material has a specific strength greater than 50,000 N·m/kg and a specific modulus greater than 24,000,000 N·m/kg. It is conducive to adopting stamping to manufacture the first main body 111a and the first cover body 112a, and conducive to providing better sealing performance for the first chamber Q1 and making the first main body 111a and the first cover body 112a thinner.

In some embodiments, the second main body 111b and the second cover body 112b are made of at least one of plastic titanium, tungsten titanium, nylon, carbon fiber, epoxy resin, cellulose acetate, cellulose propionate, or cellulose nitrate. Using the conventional temple arm materials to manufacture the second main body 111b and the second cover body 112b is conducive to improving the convenience of manufacturing the temple arm 10.

In other embodiments, the second main body 111b and the second cover body 112b are made of a metal material or other plastic materials, which is not limited in this application.

In some embodiments, the second main body 111b is provided with connecting holes 1116, and the connecting holes 1116 communicate with the third chamber Q3. The electrode terminal 121 extends into the connecting holes 1116. It is conducive to improving the convenience of electrical connection between the electrode assembly 12 and the control assembly 14. In some embodiments, the first tab 1211 and the second tab 1212 are located within the first main body 111a, the electrode posts are electrically connected to the first tab 1211 and the second tab 1212, and the electrode posts extend out of the first main body 111a and extend into the connecting holes 1116.

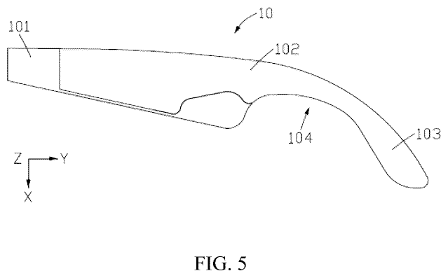

In some embodiments, referring to FIG. 5 and FIG. 6 in combination, the first main body 111a includes an ear-hook portion 104, and the ear-hook portion 104 and the second main body 111b together form an ear-hook portion. It is conducive to enabling the acoustic assembly 13 in the second chamber Q2 to be closer to the ear during wearing, thereby improving the auditory experience of the wearer.

In some embodiments, the first main body 111a and the second main body 111b are connected by bonding. It is conducive to improving the convenience of disassembling the first main body 111a and the second main body 111b. In some embodiments, an adhesive is applied on the surface where the first main body 111a is connected to the second main body 111b, so that the first main body 111a and the second main body 111b are bonded through the adhesive.

In some embodiments, the first main body 111a and the second main body 111b are connected by snap-fitting. It is conducive to improving the stability of the connection between the first main body 111a and the second main body 111b. In some embodiments, a recessed structure is provided on one of the first main body 111a and the second main body 111b, and a raised structure matching the recessed structure is provided on the other of the first main body 111a and the second main body 111b, so that the first main body 111a and the second main body 111b are snap-fitted through the recessed structure and the raised structure.

In some embodiments, the first main body 111a and the second main body 111b are connected by screwing. It is conducive to improving the connection strength between the first main body 111a and the second main body 111b. In some embodiments, a screw hole is provided in one of the first main body 111a and the second main body 111b, and a threaded structure matching the screw hole is provided in the other of the first main body 111a and the second main body 111b, so that the first main body 111a and the second main body 111b are screwed by screwing the threaded structure into the screw hole.

In some embodiments, the first main body 111a and the second main body 111b are connected by riveting. It is conducive to improving the reliability of the connection between the first main body 111a and the second main body 111b. In some embodiments, a rivet hole is provided in one of the first main body 111a and the second main body 111b, and a rivet matching the rivet hole is provided in the other of the first main body 111a and the second main body 111b, so that the first main body 111a and the second main body 111b are riveted by placing the rivet into the rivet hole.

The following illustrates the condition of the capacity increase of the electrode assembly 12 achieved by the temple arm 10 of this application with Table 1. An acoustic assembly 13 of Comparative embodiment is disposed along a second direction Y on the side that is of an electrode assembly 12 and that is close to a leg portion 103, while an acoustic assembly 13 of Embodiment 1 to Embodiment 3 is disposed along a first direction X on the side that is of an electrode assembly 12 that is close to an ear-hook portion 104. A housing 11 of Comparative embodiment is made of a plastic material. In Embodiment 1 and Embodiment 2, a first main body 111a and a second main body 111b are integrally formed. A body portion 111 and a cover portion 112 in Embodiment 1 are made of a plastic material, a body portion 111 and a cover portion 112 in Embodiment 2 are made of a metal material, and in Embodiment 3, a first main body 111a and a first cover body 112a are made of a metal material, and a second main body 111b and a second cover body 112b are made of a plastic material.

TABLE 1
Condition of Capacity Increase of Electrode Assembly 12 Achieved by Temple Arm 10 of This Application

| | | Single-side | Shell | | | | | | |
|---|---|---|---|---|---|---|---|---|---|
| | Thickness | wall | thickness | Thickness | Area | Volume | | | |
| | D0/mm of | thickness | D2/mm of | D3/mm of | S/mm² of | V/mm³ of | | | |
| | temple | D1/mm of | electrode | electrode | electrode | electrode | Capacity | Capacity | |
| Group | arm 10 | housing 11 | assembly 12 | assembly 12 | plate | assembly 12 | C/mAh | increase/% | Manufacturability |
| Comparative | 5.38 | 1.0 | 1.0 | 3.38 | 434 | 1467 | 330 | / | Easy |
| embodiment | | | | | | | | | |
| Embodiment 1 | 5.38 | 1.0 | 1.0 | 3.38 | 920 | 3110 | 699 | 112% | Easy |
| Embodiment 2 | 5.38 | 0.5 | 0.5 | 4.38 | 921 | 4034 | 907 | 175% | Difficult |
| Embodiment 3 | 5.38 | 0.5 | 0.5 | 4.38 | 921 | 4034 | 907 | 175% | Easy |

In Table 1, thickness D0 of temple arm 10=single-side wall thickness D1 of housing 11 multiplied by 2+shell thickness D2 of electrode assembly 12+thickness D3 of electrode assembly 12+assembly gap between shell of electrode assembly 12 and housing 11. In some embodiments, the shell of the electrode assembly 12 may not be included between the electrode assembly 12 and the housing 11, that is, the housing 11 of the temple arm 10 directly serves as the shell of the electrode assembly 12, which is conducive to increasing the volume available for arranging the electrode assembly 12 within the housing 11, thereby increasing the capacity of the electrode assembly 12. In this case, the shell thickness D2 of the electrode assembly 12 is equal to the single-side wall thickness D1 of the housing 11, and the assembly gap between the shell of the electrode assembly 12 and the housing 11 is 0.

In Table 1, the electrode assembly 12 is a stacked electrode assembly, and the area S of the electrode plate is the area of a single positive electrode plate. In some embodiments, the area of the positive electrode plate is smaller than that of the negative electrode plate.

In Table 1, volume V of electrode assembly 12=thickness D3 of electrode assembly 12*area S of electrode plate.

In Table 1, capacity increase=(capacity of embodiment−capacity of comparative embodiment)/capacity of comparative embodiment.

In Table 1, Comparative embodiment and Embodiment 1 both adopt injection molding to manufacture the housing 11 from the plastic material, so the manufacturability of Comparative embodiment and Embodiment 1 is easy. Embodiment 2 adopts stamping to manufacture the housing 11 from the metal material, and the overall structure of the housing 11 is relatively complex, so the manufacturability of Embodiment 2 is difficult. Embodiment 3 adopts stamping to manufacture the first main body 111a and the first cover body 112a from the metal material and adopts injection molding to manufacture the second main body 111b and the second cover body 112b from the plastic material, splitting the relatively complex overall structure of the housing 11 into two simpler structures manufactured through different processes, so the manufacturability of Embodiment 3 is easy.

In a second aspect of embodiments of this application, smart glasses are provided and include a frame, lenses and temple arms 10 provided in the first aspect, the lenses are disposed on the frame, and the temple arms 10 are connected to the frame. The temple arm 10 is conducive to increasing the capacity of the electrode assembly 12, thereby conducive to improving the battery life of the smart glasses.

In addition, a person of ordinary skill in the art understands that the above embodiments are merely intended to illustrate this application, but not intended to limit this application. Any and all appropriate modifications and changes made to the embodiments without departing from the substantial scope of this application still fall within the protection scope of this application.

What is claimed is:

1. A temple arm, comprising:
a housing, wherein the housing comprises a first chamber and a second chamber, and along a first direction, a projection of the first chamber covers a projection of the second chamber; the housing comprises an ear-hook portion, and the ear-hook portion is connected to the second chamber along a second direction; and the first direction is perpendicular to the second direction;
an electrode assembly, wherein the electrode assembly comprises an electrode terminal, and the electrode assembly is disposed in the first chamber; and
an acoustic assembly, disposed in the second chamber, wherein the acoustic assembly is electrically connected to the electrode terminal.

2. The temple arm according to claim 1, wherein the housing comprises a third chamber and a fourth chamber, the third chamber is provided with a control assembly, and the fourth chamber is provided with wiring; and the electrode terminal and the acoustic assembly are electrically connected to the control assembly, and the fourth chamber is in communication with the second chamber and the third chamber.

3. The temple arm according to claim 2, wherein the housing comprises a body portion and a cover portion, the cover portion comprises a first cover body and a second cover body, the first cover body is integrally arranged with the body portion and comprises the first chamber, and the second cover body is detachably assembled with the body portion and comprises the second chamber, the third chamber, and the fourth chamber.

4. The temple arm according to claim 3, wherein the body portion, the first cover body, and the second cover body are made of a metal material with a specific strength greater than 50,000 N·m/kg and a specific modulus greater than 24,000,000 N·m/kg, or a plastic material with a water permeability not greater than 0.01 g/m²/day.

5. The temple arm according to claim 3, wherein the body portion comprises a first main body and a second main body, and the first main body and the second main body are detachably connected; and the first cover body is integrally arranged with the first main body and comprises the first chamber, and the second cover body is detachably assembled with the second main body and comprises the second chamber, the third chamber, and the fourth chamber.

6. The temple arm according to claim 5, wherein the first main body and the first cover body are made of a metal material with a specific strength greater than 50,000 N·m/kg and a specific modulus greater than 24,000,000 N·m/kg, or a plastic material with a water permeability not greater than 0.01 g/m2/day; and the second main body and the second cover body are made of at least one of plastic titanium, tungsten titanium, nylon, carbon fiber, epoxy resin, cellulose acetate, cellulose propionate, or cellulose nitrate.

7. The temple arm according to claim 5, wherein the first main body and the second main body are connected by bonding, snap-fitting, screwing, or riveting.

8. The temple arm according to claim 5, wherein the second main body is provided with a connecting hole, and the connecting hole is in communication with the third chamber; and the electrode terminal extends into the connecting hole.

9. The temple arm according to claim 5, wherein the first main body comprises the ear-hook portion, and the ear-hook portion and the second main body together form an ear-hook region.

10. The temple arm according to claim 1, wherein the ear-hook portion is recessed along a direction opposite to the first direction.

11. The temple arm according to claim 1, wherein the electrode terminal extends out of the first chamber and is located within the housing.

12. The temple arm according to claim 1, wherein the temple arm is internally provided with an electrolyte solution, and the electrolyte solution is directly accommodated in the first chamber.

13. Smart glasses, comprising a frame, lenses, and temple arms, wherein the lenses are disposed on the frame, and the temple arms are connected to the frame; and
at least one of the temple arms comprises:
a housing, wherein the housing comprises a first chamber and a second chamber, and along a first direction, a projection of the first chamber covers a projection of the second chamber; the housing comprises an ear-hook portion, and the ear-hook portion is connected to the second chamber along a second direction; and the first direction is perpendicular to the second direction;
an electrode assembly, wherein the electrode assembly comprises an electrode terminal, and the electrode assembly is disposed in the first chamber; and
an acoustic assembly, disposed in the second chamber, wherein the acoustic assembly is electrically connected to the electrode terminal.

14. The smart glasses according to claim 13, wherein the housing comprises a third chamber and a fourth chamber, the third chamber is provided with a control assembly, and the fourth chamber is provided with wiring; and the electrode terminal and the acoustic assembly are electrically connected to the control assembly, and the fourth chamber is in communication with the second chamber and the third chamber.

15. The smart glasses according to claim 14, wherein the housing comprises a body portion and a cover portion, the cover portion comprises a first cover body and a second cover body, the first cover body is integrally arranged with the body portion and comprises the first chamber, and the second cover body is detachably assembled with the body portion and comprises the second chamber, the third chamber, and the fourth chamber.

16. The smart glasses according to claim 15, wherein the body portion, the first cover body, and the second cover body are made of a metal material with a specific strength greater than 50,000 N·m/kg and a specific modulus greater than 24,000,000 N·m/kg, or a plastic material with a water permeability not greater than 0.01 g/m²/day.

17. The smart glasses according to claim 15, wherein the body portion comprises a first main body and a second main body, and the first main body and the second main body are detachably connected; and the first cover body is integrally arranged with the first main body and comprises the first chamber, and the second cover body is detachably assembled with the second main body and comprises the second chamber, the third chamber, and the fourth chamber.

18. The smart glasses according to claim 17, wherein the first main body and the first cover body are made of a metal material with a specific strength greater than 50,000 N·m/kg and a specific modulus greater than 24,000,000 N·m/kg, or a plastic material with a water permeability not greater than 0.01 g/m2/day; and the second main body and the second cover body are made of at least one of plastic titanium, tungsten titanium, nylon, carbon fiber, epoxy resin, cellulose acetate, cellulose propionate, or cellulose nitrate.

19. The smart glasses according to claim 17, wherein the second main body is provided with a connecting hole, and the connecting hole is in communication with the third chamber; and the electrode terminal extends into the connecting hole.

20. The smart glasses according to claim 13, wherein the at least one of the temple arms is internally provided with an electrolyte solution, and the electrolyte solution is directly accommodated in the first chamber.
